(19) United States
(12) Patent Application Publication
(10) Pub. No.: US 2022/0098063 A1
(43) Pub. Date: Mar. 31, 2022

(54) ELECTROLYZED OZONE WATER GENERATOR COMPOSED OF COATED TITANIUM ANODES

(71) Applicant: Yantai United Ozonetec Corporation, Yantai (CN)

(72) Inventors: MING-YUNG HSU, Yantai (CN); WEI-CHUN HSU, Yantai (CN)

(21) Appl. No.: 17/033,927

(22) Filed: Sep. 28, 2020

(51) Int. Cl. C02F 1/461; C02F 1/467

(52) U.S. Cl. CPC C02F 1/46109; C02F 2303/04; C02F 2001/46142; C02F 1/4672

(57) ABSTRACT

The present disclosure exhibits an electrolyzed ozone water ozone water generator composed of coated titanium anode. An electrolyzed ozone water composed of coated titanium anode includes n anodes and n+1 cathodes, wherein the anodes are coated titanium anodes, and the cathodes are titanium cathodes or stainless-steel cathodes. The coated titanium anode includes a titanium substrate and a tin dioxide coating layer doped with ruthenium and nickel, which is made by etching and drying the titanium substrate roughened by sandblasting, and then evenly spreading the titanium substrate with a tin dioxide coating solution doped with ruthenium and nickel, and drying, and thermally decomposing the coating material. The anode and cathode are immersed in water with a conductivity greater than 30 μs/cm, powered by a constant current, and the power supply voltage ranges from 3.5 to 12V. The water is electrolyzed under the action of an electric field, and the oxygen ions generate ozone microbubbles under the action of the anode catalyst. The ozone microbubbles rapidly dissolve into the water directly generating ozone water. The generator of the present disclosure is environmentally friendly, low cost, simple process operation, and easy to scale production; the generator is easy to replace, convenient to use, simple in structure and low in cost.

### BACKGROUND OF THE INVENTION

### Technical Field of the Invention

The present disclosure relates to an electrolyzed ozone water generator composed of coated titanium anodes, which belongs to the technical field of electrolytic electrolysis ozone water generators.

### Background

At present, electrolyzed ozone generators that use electrolyzed water to generate ozone mostly use lead dioxide as the anode material. Because lead dioxide is easily poisoned that reduces its catalytic activity, tap water cannot be used directly as electrolyzed water, but ultrapure water can only be used as electrolyzed water to keep the generator performance stable. In many applications, pure water is electrolyzed to produce ozone gas and then mixed with ordinary water to produce ozone water through mixing technology, which also increases the complexity of ozone equipment. Furthermore, because of the use of lead dioxide as the anode, the electrolyzed ozone generator of such material will denature the surface of lead dioxide and thereby losing catalytic activity of lead dioxide due to the reverse movement of hydrogen ions when exchanging status of turning on and off frequently. Therefore, it is necessary to find a way to generate ozone water that directly uses tap water as electrolyzed water.

### SUMMARY OF INVENTION

The purpose of the present disclosure is to overcome the shortcomings of the prior art and provide an electrolyzed ozone water generator composed of coated titanium anodes. The present disclosure directly uses tap water as water for electrolysis to directly produce ozone water, to solve the problem of catalyst poisoning of the lead dioxide catalyst thereby losing catalytic activity and environmental pollution of lead, and low cost, simple process operation, easy to scale production, easy to replace the generator, easy to operate and use.

The technical solution provided by the present disclosure is as follows:

the beneficial effects of the present disclosure are:

1. In the present disclosure, the tin dioxide coating layer is used as the material of anodes to solve the problem of catalyst poisoning of the lead dioxide catalyst thereby losing catalytic activity and environmental pollution of lead, and the tin dioxide is low cost.

2. The electrolytic ozone water generator of the present disclosure is connected to a constant direct current, the water is electrolyzed under the action of an electric field, and the oxygen ions generate ozone microbubbles under the action of the anode catalyst. The ozone microbubbles are quickly dissolved into the water to directly generate ozone water. The step of producing ozone gas and then mixing with water to produce ozone water, which is currently commonly used, is omitted, and the product made by the present disclosure has a simple structure and low cost.

3. The process of the present disclosure is simple to operate and easy to scale production.

4. The electrolyzed ozone water generator constructed by the present disclosure is easy to replace and convenient to operate and use.

### BRIEF DESCRIPTION OF THE DRAWINGS

FIG. 1 is a schematic view of an electrolyzed ozone water generator composed of coated titanium anodes according to the present disclosure.

### DETAILED DESCRIPTION OF THE INVENTION

The specific embodiments of the present invention will be described in detail below with reference to the drawings.

### Example 1

A 1 mm thick punched titanium plate of 1000 cm² with a diameter of 3 mm and a hole density of 1 per square centimeter is taken to sandblasted and roughened, and then the sandblasted and roughened punched titanium plate is placed in a hydrochloric acid aqueous solution with a volume percentage concentration of 30% and heated to 90° C. to be etched for 5 minutes. The etched punched titanium plate is rinsed with pure water and stored in a hydrochloric acid aqueous solution with a volume percentage concentration of 3% for use.

30 grams of tin chloride pentahydrate, 3.9 grams of ruthenium chloride containing 37% ruthenium, and 1.13 grams of nickel chloride hexahydrate is taken to be dissolved in a solution containing 30.9 ml of butyl titanate, 9 ml of nitric acid and 300 ml of ethanol to form into a tin dioxide coating solution doped with ruthenium and nickel.

The punched titanium plate is taken out and dried.

The above-mentioned tin dioxide coating solution doped with ruthenium and nickel is smeared evenly on the punched titanium plate, dried in an infrared oven at 120° C. for 6 minutes, and placed in a high temperature furnace at 420° C. for 10 minutes to thermally decompose the coating material. The steps of smearing, drying and high-temperature thermal decomposition are repeated 8 times, and the furnace temperature is adjusted to 500° C. for the last time and kept for 2 hours before being taken out. The tin dioxide coated titanium anode is produced and ready for use.

### Example 2

A 0.6 mm thick punched titanium plate of 1000 cm² is taken to sandblasted and roughened, and then the sandblasted and roughened punched titanium plate is placed in a hydrochloric acid aqueous solution with a volume percentage concentration of 20% and heated to 90° C. to be etched for 8 minutes. The etched punched titanium plate is rinsed with pure water and stored in a hydrochloric acid aqueous solution with a volume percentage concentration of 2% for use.

30 grams of tin chloride pentahydrate, 3 grams of ruthenium chloride containing 37% ruthenium, and 0.5 grams of nickel chloride hexahydrate is taken to be dissolved in a solution containing 20 ml of butyl titanate, 5 ml of nitric acid and 300 ml of ethanol to form into a tin dioxide coating solution doped with ruthenium and nickel.

The punched titanium plate is taken out and dried.

The above-mentioned tin dioxide coating solution doped with ruthenium and nickel is smeared evenly on the punched titanium plate, dried in an infrared oven at 130° C. for 3 minutes, and placed in a high temperature furnace at 400° C. for 15 minutes to thermally decompose the coating material. The steps of smearing, drying and high-temperature thermal decomposition are repeated 12 times, and the furnace temperature is adjusted to 480° C. for the last time and kept for 3 hours before being taken out. The tin dioxide coated titanium anode is produced and ready for use.

### Example 3

A 4×6 mm stretched titanium mesh plate of 1000 cm² after flattening treatment is taken to sandblasted and roughened, and then the sandblasted and roughened stretched titanium mesh plate is placed in a hydrochloric acid aqueous solution with a volume percentage concentration of 10% and heated to 90° C. to be etched for 8 minutes. The etched stretched titanium mesh plate is rinsed with pure water and stored in a hydrochloric acid aqueous solution with a volume percentage concentration of 1% for use.

30 grams of tin chloride pentahydrate, 2.34 grams of ruthenium chloride containing 37% ruthenium, and 0.204 grams of nickel chloride hexahydrate is taken to be dissolved in a solution containing 9.09 ml of butyl titanate, 3 ml of nitric acid and 300 ml of ethanol to form into a tin dioxide coating solution doped with ruthenium and nickel.

The titanium mesh plate is taken out and dried.

The above-mentioned tin dioxide coating solution doped with ruthenium and nickel is smeared evenly on the titanium plate, dried in an infrared oven at 90° C. for 10 minutes, and placed in a high temperature furnace at 450° C. for 8 minutes to thermally decompose the coating material. The steps of smearing, drying and high-temperature thermal decomposition are repeated 5 times, and the furnace temperature is adjusted to 520° C. for the last time and kept for 1 hours before being taken out. The tin dioxide coated titanium anode is produced and ready for use.

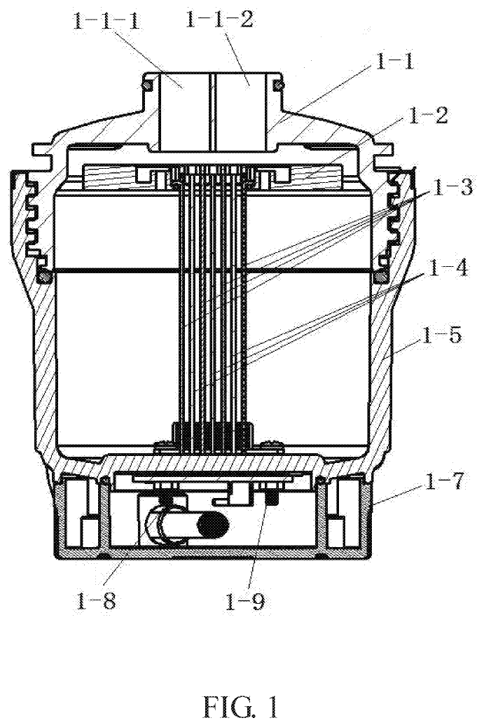

As shown in FIG. 1, an electrolyzed ozone water generator composed of coated titanium anode, which includes n anodes and n+1 cathodes, n is an integer, n 1. The anodes (1-4) and the cathodes (1-3) are arranged crosswise, in order to ensure the largest effective area. The anodes are the coated titanium anodes, at least one sheet. The cathodes are titanium cathodes or stainless-steel cathodes, preferably titanium plate cathodes. The bottom of each of the anodes (1-4) is electrically connected to another, and the bottom of each of the cathodes (1-3) is electrically connected to another. The anodes (1-4) and the cathodes (1-3) are fixed in a shelled container barrel (1-5) and respectively connected to the positive and negative electrodes of the generator through an anode conductive stud (1-9) and a cathode conductive stud (1-8). A bottom cover (1-7) is set at the bottom of the shelled container barrel (1-5) to protect the electronically conductive parts. The top of the anodes (1-4) and the top of cathodes (1-3) are provided with a separator (1-2) to avoid a short circuit between the anodes and the cathodes. The top of the shelled container barrel (1-5) is provided with an upper cover (1-1), and the upper cover (1-1) is provided with a water inlet (1-1-1) and a water outlet (1-1-2). The anodes (1-4) and the cathodes (1-3) are respectively connected to the positive and negative electrodes of the generator through an anode conductive stud (1-9) and a cathode conductive stud (1-8).

At first, the anodes and the cathodes of the electrolyzed ozone water generator composed of coated titanium anodes is immersed into water with a conductivity greater than 30 μs/cm. Then, the anodes and the cathodes are powered by a constant current at a power supply voltage ranging between 3.5V and 12V, the water with a conductivity greater than 30 μs/cm passes through the water inlet (1-1-1) and into the inside of the generator. The positive and negative electrodes that supply power to the generator provide constant current power supply to the generator through the cathode conductive stud (1-8) and the anode conductive stud (1-9) at a power supply voltage ranging between 3.5V and 12V. The water with a conductivity greater than 30 μs/cm is electrolyzed under the action of an electric field, and the ozone microbubbles are generated via oxygen ions under the action of the anode catalyst. The ozone microbubbles are quickly dissolved into the water to directly generate the ozone water. The ozone water passes through a water outlet (1-1-2) for the use of removing the biofilm on the pipe wall and sterilizing the pipe water.

1. An electrolyzed ozone water generator composed of coated titanium anode, characterized in that the electrolyzed ozone water generator comprises n anodes being coated titanium anodes and n+1 cathodes being titanium cathodes or stainless-steel cathodes, n is an integer, n≥1; the coated titanium anode includes a titanium substrate and a tin dioxide coating layer doped with ruthenium and nickel, wherein in the coating layer doped with ruthenium and nickel, the atomic ratio of tin and ruthenium is 6:1˜10:1, and the atomic ratio of ruthenium and nickel is 3:1˜10:1.

2. The electrolyzed ozone water generator composed of coated titanium anode according to claim 1, characterized in that the anodes (1-4) and the cathodes (1-3) are arranged crosswise, a bottom of each anode (1-4) is electrically connected to another, and a bottom of each cathode (1-3) is electrically connected to another; the anodes (1-4) and the cathodes (1-3) are fixed in a shelled container barrel (1-5), a bottom cover (1-7) is set at the bottom of the shelled container barrel (1-5); the top of the anodes (1-4) and the top of cathodes (1-3) are provided with a separator (1-2), The top of the shelled container barrel (1-5) is provided with an upper cover (1-1), and the upper cover (1-1) is provided with a water inlet (1-1-1) and a water outlet (1-1-2). The anodes (1-4) and the cathodes (1-3) are respectively connected to the positive and negative electrodes of the generator through an anode conductive stud (1-9) and a cathode conductive stud (1-8).

3. The electrolyzed ozone water generator composed of coated titanium anode according to claim 1, characterized in that the coated titanium anode includes a titanium substrate and a tin dioxide coating layer doped with ruthenium and nickel, wherein in the coating layer doped with ruthenium and nickel, the atomic ratio of tin and ruthenium is 6:1˜10:1, and the atomic ratio of ruthenium and nickel is 3:1˜10:1.

4. The electrolyzed ozone water generator composed of coated titanium anode according to claim 3, characterized in that the electrolyzed ozone water generator is prepared by a method having steps of:
a. roughening a titanium substrate by sandblasting;
b. etching the roughened titanium substrate by hydrochloric acid aqueous solution with a volume percentage concentration of 10 to 30%;
c. rinsing the etched titanium substrate with pure water and storing the titanium substrate in hydrochloric acid aqueous solution with a volume percentage concentration of 1 to 3% for use;
d. drying the titanium substrate, and then evenly spreading a tin dioxide coating solution doped with ruthenium and nickel on the titanium substrate;
e. drying the titanium substrate coated with the tin dioxide coating solution doped with ruthenium and nickel in an infrared oven at 90-130° C. for 3-10 minutes;
f. thermally decomposing the coating material in 8-15 minutes in a furnace at 400° C.-450° C.; and
g. repeating steps d to f for 5 to 12 times, and finally adjusting the furnace temperature to 480-520° C. and keeping the temperature for 1 to 3 hours before taking out.

5. The electrolyzed ozone water generator composed of coated titanium anode according to claim 4, characterized in that the electrolyzed ozone water generator is prepared by a method having steps of:
taking nitric acid with a volume percentage concentration of 1 to 3% dissolved into the ethanol solution to form a nitrate ethanol solution, taking 3-10% butyl titanate dissolved in the nitrate ethanol solution to form a butyl titanate nitrate ethanol solution, and taking tin chloride, ruthenium chloride and nickel chloride dissolved into the butyl titanate nitrate ethanol solution; the atomic ratio of tin and ruthenium in the butyl titanate nitrate ethanol solution is 6:1˜10:1, and the atomic ratio of ruthenium and nickel in the butyl titanate nitrate ethanol solution is 3:1˜10:1.

6. The electrolyzed ozone water generator composed of coated titanium anodes according to claim 1, which produce ozone water by steps of:
at first immersing the anodes and the cathodes of the electrolyzed ozone water generator composed of coated titanium anode into water with a conductivity greater than 30 μs/cm; powering the anodes and the cathodes by a constant current at a power supply voltage ranging between 3.5V and 12V, electrolyzing water under the action of an electric field, and generating ozone microbubbles via oxygen ions under the action of the anode catalyst, and quickly dissolving the ozone microbubbles into the water to directly generate the ozone water.
